(19) United States
(12) Patent Application Publication
(10) Pub. No.: US 2011/0280632 A1
(43) Pub. Date: Nov. 17, 2011

(54) ELECTROPHOTOGRAPHIC DEVELOPMENT APPARATUS

(76) Inventor: Frederic M. Douglas, Irvine, CA (US)

(21) Appl. No.: 13/106,846

(22) Filed: May 12, 2011

Related U.S. Application Data
(60) Provisional application No. 61/395,423, filed on May 13, 2010.

(51) Int. Cl. G03G 15/08

(52) U.S. Cl. 399/265

(57) ABSTRACT

The present invention is directed to a non-contact, single-component developing system for electrophotographic machines that effectively reduces the effect of adhesion forces on the development process. The developing system of the present invention uses a thin layer forming member where R_{z} is less than or equal to 6.65 μm. Also, the system uses a predetermined length for the thin layer forming member, to control pressing force by the thin layer forming member on the toner and toner support member. The distance from the contact point to the edge is less than or equal to r×(tan θ). Angle θ is spanned by the contact point and the edge; r is the toner support member radius.

### CROSS REFERENCE TO RELATED APPLICATION

This application claims priority of Provisional Patent Application Ser. No. 61/395,423 filed on May 13, 2010, the contents of which are incorporated by reference.

### FIELD OF THE INVENTION

The present invention relates generally to electrophotography, more particularly, to a non-contact, single-component developing system and single-component toner that facilitates efficient development of an electrostatic image and consistent high quality image output.

### BACKGROUND OF THE INVENTION

Electrophotographic imaging process (or xerography) is a well-known method of copying or otherwise printing documents. In general, electrophotographic imaging uses a charge-retentive, photosensitive surface (known as a photoreceptor) that is initially charged uniformly. The photoreceptor is then exposed to a light image representation of a desired image that discharges specific areas of the photoreceptor surface creating a latent image. Toner powder is applied by using a developing system, which carries the toner from a toner container to the latent image, forming a developed image. This developed image is then transferred from the photoreceptor to a substrate (e.g. paper, transparency, and the like).

A color electrophotographic imaging process is typically achieved by repeating the same process described above for each color or tone of toner desired and storing each developed image to an intermediate accumulator until all desired colors or tones are achieved and then transferred to a substrate (e.g. paper, transparency, and the like).

There are several developing systems known in the art that carry the toner to the developing region and develop the latent image. One process is known as a “non-contact” or “jump” developing system. In operation, a thin layer of toner is adhered to a toner support member in spaced relation with respect to the latent image-bearing surface of the photoreceptor. When the toner is carried to the developing region between the toner support member and the photoreceptor, a bias voltage associated with the latent image areas of the photoreceptor tends to exert electrostatic forces that direct the toner particles towards the latent image areas on the surface of the photoreceptor. The electrostatic forces are often of insufficient magnitude to overcome the adhesion forces holding the toner particles in the thin layer on the toner support member. One solution is to apply high AC voltage to the developing region. The AC voltage agitates the toner particles to free them from the toner support member, enabling the toner particles to “jump” the gap between the toner support member and the photoreceptor. The toner particles that jump the gap adhere to the latent image areas on the surface of the photoreceptor to form a developed image. For color or “tone-on-tone” developing, this process is repeated and the developed images containing individual colors are transferred to and stored on an intermediate accumulator until all desired colors or tones are achieved and then transferred to a substrate (e.g. paper, transparency, and the like). Although this process will produce color and tone-on-tone images with sufficient efficiency, the addition of an intermediate accumulator increases the complexity and cost of the electrophotographic imaging system.

However, using AC voltage provides a disadvantage due to the alternating current inducing the toner particles to jump across the gap in alternate or opposing directions. The toner jumps in the desired direction, from the toner support member to the photoreceptor and in the reverse, from the photoreceptor to the toner support member. The reverse jump is sometimes referred to as “scavenging.” Scavenging involves the undesired removal of toner from the photoreceptor after the toner had successfully developed onto the photoreceptor image surface. Using only a direct current (DC) bias removes the alternating character that contributes to scavenging.

Although previous efforts have been made to produce a non-contact developing system for multi-color imaging utilizing a single component toner and accumulation of the image on a single photoconductor (i.e., no intermediate accumulator), none of these efforts appears to have resulted in a system that effectively develops color toner particles to a photoreceptor with sufficient efficiency.

In addition, previous efforts have been made to produce a non-contact developing system for monochrome imaging using a single component toner and using DC bias only. None of these efforts appears to have resulted in a system that effectively develops toner particles to a photoreceptor with sufficient efficiency.

As can be seen, there is a need for an improved apparatus and method of non-contact, monocomponent development that optionally uses only a DC voltage bias, does not use an intermediate accumulator, and provides efficient development at high speeds.

### SUMMARY OF THE INVENTION

In one aspect of the invention, a non-contact, single-component developing system comprises a photoreceptor capable of having an electrostatic latent image recorded thereon; and a toner support member disposed in opposing relationship with the photoreceptor with a gap there between defining a developing region, the toner support member adapted to carry a toner thereon to the developing region; wherein the toner comprises toner mixed with large and small extraparticulate particles, a weight concentration of small extraparticulate particles resulting in a first surface coverage of the toner in a range of about 50 to 150 percent and a weight concentration of large extraparticulate particles resulting in a second surface coverage of the toner in a range of about 5 to 50 percent.

In another aspect of the invention, a single component toner comprises a plurality of toner particles; a first plurality of extraparticulate particles; and a second plurality of extraparticulate particles; wherein the first and second plurality of extraparticulate particles are mixed with the plurality of toner particles at a concentration of first plurality of extraparticulate particles resulting in a first surface coverage of the plurality of toner particles in a range of about 50 to 150 percent and a concentration of second plurality of extraparticulate particles resulting in a second surface coverage of the plurality of toner particles in a range of about 5 to 50 percent.

In a further aspect of the invention, a non-contact single pass electrophotographic imaging process comprises the steps of creating a latent image on a surface of a photoreceptor, and developing the latent image into a developed image by forcing toner particles across a gap between a toner support member and the photoreceptor without AC voltage.

In yet another aspect of the present invention, an imaging apparatus may comprise; a toner support member, and a thin layer forming member for forming toner on the toner support member, wherein a surface roughness R_{z} of the thin layer forming member, on the thin layer forming member surface facing the toner support member, is less than or equal to 6.65 μm or even less than or equal to 1.65 μm (micro-meter).

In a yet further aspect of the present invention, an electrophotographic development apparatus comprises; a toner support member, and a thin layer forming member for forming toner on the toner support member, wherein a distance L from a contact point of the toner support member to the free edge of the thin layer forming member is set to meet the following equation:

0<L≦r×(tan θ),

where L denotes the distance, r an outer radius of the toner support member, and θ is an angle formed by the point, on the free edge of the thin layer forming member, closest to the toner support member at a position in an upstream side relative to a rotational direction of the toner support member from a contact point of the thin film forming member and the toner support member.

In a still further aspect of the present invention, an electrophotographic development apparatus comprises; a toner support member, and a thin layer forming member for forming toner on the toner support member, wherein a distance L from a contact point of the toner support member to the free edge of the thin layer forming member is set to meet the following equation:

0<L≦r×(tan θ),

where L denotes the distance, r an outer radius of the toner support member, and θ is an angle formed by the point, on the free edge of the thin layer forming member, closest to the toner support member at a position in an upstream side in an opposite direction from a rotational direction of the toner support member from a contact point of the thin film forming member and the toner support member.

In yet another aspect of the present invention, An electrophotographic development apparatus comprises; a toner support member, and a thin layer forming member for forming toner on the toner support member, wherein a distance L from a contact point of the toner support member to the free edge of the thin layer forming member is set to meet the following equation:

0<L≦r×(tan θ),

where L denotes the distance, r an outer radius of the toner support member, and θ is an angle formed by the point, on the free edge of the thin layer forming member, closest to the toner support member at a position in a downstream side relative to a rotational direction of the toner support member from a contact point.

Other innovative aspects of the invention include the preceding aspects individually or in combination. These and other features, aspects and advantages of the present invention will become better understood with reference to the following drawings, description and claims.

### BRIEF DESCRIPTION OF THE DRAWINGS

FIG. 1 is a schematic of a non-contact, single-component developing system of the present invention;

FIG. 2 is a schematic illustrating the forces acting upon a toner particle during the development process;

FIG. 3A is a schematic of a non-contact, single-component color developing system in accordance with the present invention;

FIG. 3B is a partial schematic of the non-contact, single-component color developing system shown in FIG. 3A;

FIG. 4 is a plan view of a toner particle with silica particles adhered thereto;

FIG. 5 is a graph showing a typical particle size distribution for silica;

FIG. 6 is a graph showing a typical particle size distribution for toner particles having a mean diameter of 16 μm;

FIG. 7 is a graph showing development efficiency;

FIG. 8 is a graph showing development efficiency;

FIG. 9 is a graph showing development efficiency;

FIG. 10 is a graph showing development efficiency;

FIG. 11 is a graph showing development efficiency;

FIG. 12 is a graph showing development efficiency;

FIG. 13 is a graph showing development efficiency;

FIG. 14 is a schematic illustrating the calculated surface area coverage;

FIG. 15 is a plan view of an irregular shaped toner particle according to the present invention;

FIG. 16 illustrates a simulation of a particle with spherical symmetric charge distribution;

FIG. 17 illustrates a computer simulation of the image forces and correction factor resulting from the simulation in FIG. 16;

FIG. 18 illustrates a plan view of an irregular shaped toner particle with extraparticulate particles according to the preferred embodiment of the present invention;

FIG. 19 illustrates the interaction between the toner particle and the surface roughness profile of the developer roller;

FIG. 20 illustrates doctor blade and development roller surface interactions when charging toner particles; and

FIG. 21 is a cross sectional view showing the developer roller and the doctor blade.

### DETAILED DESCRIPTION OF PREFERRED EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention is directed to a non-contact, single-component developing system for electrophotographic machines that effectively reduces the effect of toner adhesion forces on the development process and facilitates toner jump while eliminating the need for AC bias voltages and, thus, an intermediate accumulator or some other intermediate transfer member. The present invention can be used, but is not limited by, electrophotographic printers, copiers, and multi-function machines (one device to print/scan/fax/copy). In a particularly innovative aspect, the developing system of the present invention uses a single-component toner that tends to reduce adhesion forces that tend to adhere toner particles to a toner support member surface. This toner is used in combination with a defined roughness of the toner support member surface to further reduce adhesion forces between the toner and the toner support member surface.

To achieve these and other advantages and in accordance with the purpose of the present invention, as embodied and broadly described, a toner support member has a surface roughness such that the surface is smooth on the order of comparison of the size of a toner particle (for example, 12 μm) and a toner comprising a toner particle having an irregular shape, less than ten contact points between the particle and the surface of a ground plane such as a toner support member (for example, a developer roller), and exhibits adhesion forces that are the sum total of the image forces, van der Waals forces, and “proximity” forces acting on the toner particle.

The toner adhesion force is customarily based on the calculation of the image force Fᵢ,

$${F}_{i} = \frac{α}{4 {πɛ}_{0}} \frac{{Q}^{2}}{{d}^{2}} \qquad ( Equation 1 )$$

where Q is the toner charge, d is the toner diameter, ∈₀ is the permitivity of free space, and α is a correction factor, which depends on the dielectric constant of the toner particle. The relation in Equation 1 is not a complete representation of the forces involved in toner adhesion, as the toner adhesion force also includes van der Waals forces, since molecules in close contact across an interface interact by dipole-dipole interactions. The van der Waals force, F_{w}, is calculated as

F_{w}=1.5ω_{A}πR (Equation 2)

where R is the radius of the toner particle and ω_{A} is the thermodynamic work of adhesion and is related to the surface energies, γ, of the toner particle.

Previously, those skilled in the art have always assumed that the toner particle has a spherically symmetric charge distribution in contact with a perfectly smooth ground plane. However, the image force, as calculated by Equation 1, has been shown to be only valid far from a ground plane. Consequently, to satisfy the need to reduce the effect of adhesion forces on the development process, a new toner and a new surface roughness for the toner support member are needed in which the negative effect of adhesion forces is reduced.

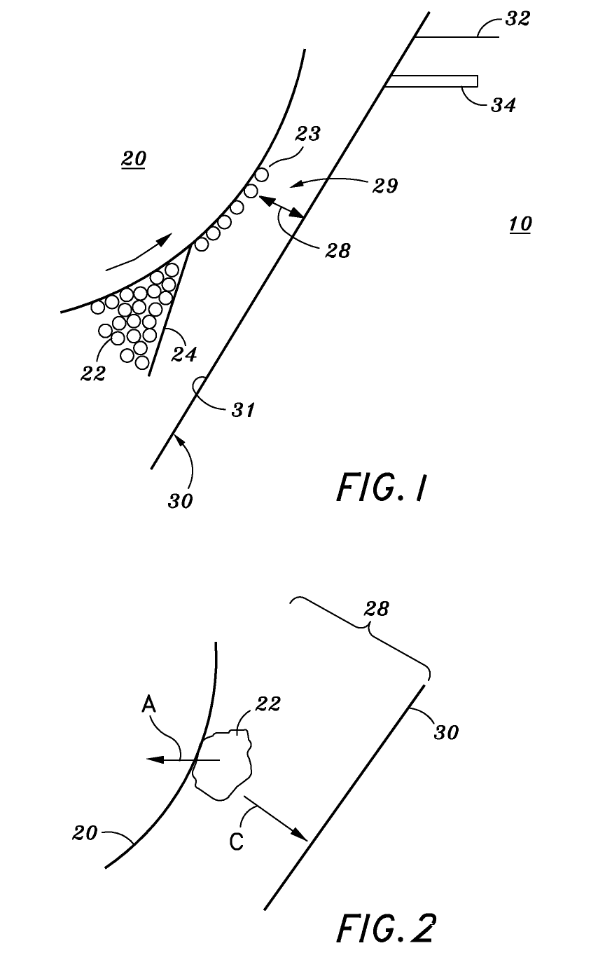

FIG. 15 illustrates a plan view of an irregularly shaped toner particle according to one embodiment. The toner particle 40 rests on a ground plane 50 of a toner support member, such as the developer roller 20 of FIG. 1. The toner particle 40 in FIG. 15, for example, has contact points 52 and 54 with the ground plane 50. Preferably, the toner particle 40 of the present invention has less than ten contact points with the ground plane 50. The toner particle 40 exhibits an irregular shape (as opposed to spherical) and contains surface ridges and creases to maximize the overall surface area of the particle. Also, the irregular shape allows the toner particle 40 to have more than one contact point with a ground plane. The toner particle 40, with its irregular shape and multiple contact points, exhibits adhesion forces which are the sum of the image forces, van der Waals forces and a third additional force, as described below.

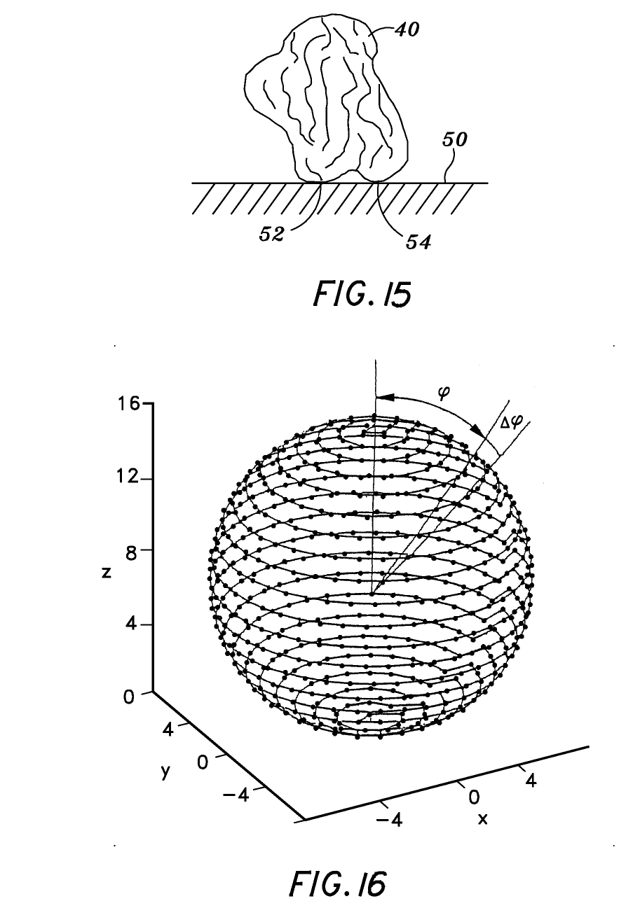

In order to overcome the inconsistencies of the prior art, the additional force, called the “proximity force,” acts on a toner particle during the development process. If the toner particle had a spherically symmetric charge distribution and was in contact with a metal plane, a proximity force, equal to approximately 4/π times the image force was calculated. Analytically, the total charge of a spherical toner particle was assumed to be distributed uniformly in lumps around the surface of the toner particle, as shown in the simulation of FIG. 16. The image forces between a charge lump and its image charge on the metal plane were analyzed and it was found that a proximity force, Fₚ, was

$${F}_{p} = \frac{4}{π} \frac{1}{4 {πɛ}_{0}} \frac{{Q}^{2}}{{d}^{2}} \qquad ( Equation 3 )$$

which characterized the force between the charge lumps nearest the metal plane and their images on the metal plane. In principle, all of the other image charge lumps (on the metal plane) contribute to the forces on the closest charge lumps, but their contribution falls off very rapidly and is second order.

Since the number of proximity point lumps are much less than the total number of charge lumps on the surface of the toner particle, the non-proximity charge lumps can be considered a complete spherical charge which can be modeled by placing a single charge in the center of the sphere according to the prior art. Consequently, the second force is simply the image force as calculated by Equation 1. The total force on the particle is the sum of these two forces.

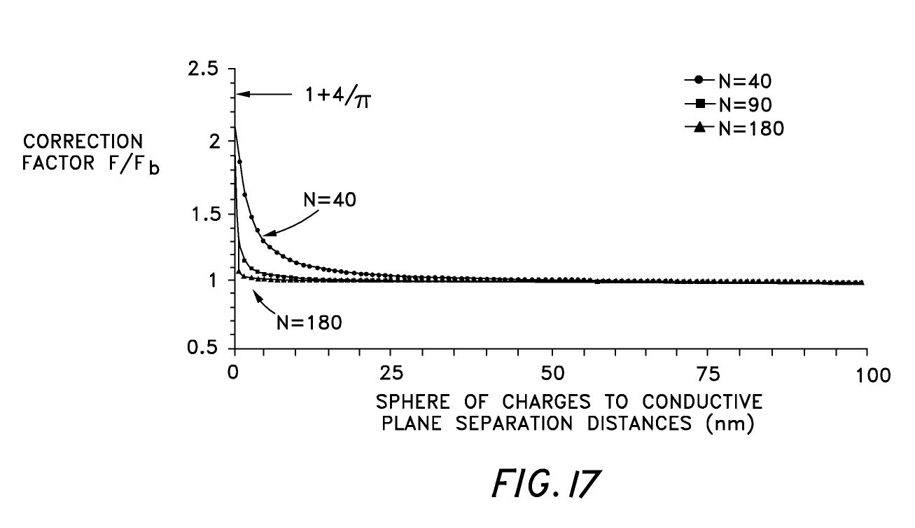

A computer simulation was performed to verify this result and is shown in FIG. 17. The simulation used the charge lumping process described above. In addition, all of the forces between all of the charge lumps (as opposed to pairing) were considered and the distance between the sphere and the metal plane was varied. Also, the number of charge planes was varied (from 40, 90, and 180), which varied the number of charge lumps (from approximately 20,000, approximately 100,000, and approximately 400,000). As shown in FIG. 17, the result (1+4/π) was obtained. Subsequently, the identification of the proximity force provides for a new application of toner synthesis in which adhesion forces can be further minimized.

Since toner particles are not perfect spheres and have many contact points, there is a proximity force active at each contact point. Consequently, if there are n contact points, and α is set to equal 1.0, the electrostatic force of adhesion is then

$$F = \frac{1}{4 {πɛ}_{0}} \frac{{Q}^{2}}{{d}^{2}} + n \frac{4}{π} \frac{1}{4 {πɛ}_{0}} \frac{{Q}^{2}}{{d}^{2}} \qquad ( Equation 4 )$$

However, this calculation ignores the effects due to dielectric properties of the toner. At each contact point, the possibility of van der Waals forces exists also. Therefore, the total adhesion force F_{T} is

$${F}_{T} = \frac{1}{4 {πɛ}_{0}} \frac{{Q}^{2}}{{d}^{2}} + n \frac{4}{π} \frac{1}{4 {πɛ}_{0}} \frac{{Q}^{2}}{{d}^{2}} + n \frac{3}{2} {ω}_{A} π R \qquad ( Equation 5 )$$

An electric field detachment experiment was carried out in a single component development system in which the toner of the preferred embodiment is charged against a metal toner support or developer roller after passing under a counter rotating toner supply roller and a polyurethane metering bar. A metal cylinder was spaced 150 microns from the developer roller rotating at the same speed (tests were conducted at 0, 27.5, 55, and 110 mm/s). A bias voltage between the metal cylinder and the developer roller provided the electrostatic energy to conduct this experiment. The toner of the preferred embodiment transferred from the developer roller to the metal cylinder when the Coulombic force exceeded the adhesion force, F_{T}.

The experiments showed that when the number of contact points was less than ten, the total adhesion forces, as calculated and described above were minimized and the Coulombic force was sufficiently greater than the adhesion forces to allow development. The Coulombic force is equal to QE, where E is the applied electric field (voltage of the developer roller subtracted from the voltage of the image bearing substrate) and can be expressed as V/L, where L is the gap between the developer roller and the image bearing substrate (150 microns in this case) and V is the difference in voltage as described above.

Further experimentation showed a need to distinguish the number of potentially electrostatic contact points resulting from van der Waals forces at sites on the toner particle that were not in contact with the developer roller. Therefore, Equation 5 is altered to reflect this:

$${F}_{T} = \frac{1}{4 {πɛ}_{0}} \frac{{Q}^{2}}{{d}^{2}} + {n}_{P} \frac{4}{π} \frac{1}{4 {πɛ}_{0}} \frac{{Q}^{2}}{{d}^{2}} + n \frac{3}{2} {ω}_{A} π R \qquad ( Equation 5 )$$

where n_{P} is the number of contact points attributed to the proximate force and n is the number of contact points attributed to van der Waals forces.

FIG. 18 illustrates a plan view of an irregularly shaped toner particle according to one embodiment of the present invention. In FIG. 18, large and small extraparticulate particles such as 202 and 201, respectively, cover the surface of the toner particle 40. The extraparticulate particles may be composed of hydrophobic silica, as illustrated in U.S. Pat. No. 6,605,402. Alternatively, the particles may be comprised of an extraparticulate with similar physical characteristics to silica including material such as titanium dioxide, polymer microspheres, polymer beads, cerium oxide, zinc stearate, alumina, and the like. Surface coverage of toner particles by large extraparticulate particles may be in a range of about 5 to 50 percent and surface coverage of toner particles by small extraparticulate particles may be in a range of about 50 to 150 percent. The number of contact points between a toner particle covered with silica and the surface of a developer roller may increase or decrease. Alternatively, the surface of the toner particle 40 may be covered with only one size of extraparticulate particles (not shown), wherein surface coverage of the toner particle is in a range of about 5 to 50 percent. However, for either this or the embodiment shown in FIG. 18, the number of contact points remains less than ten.

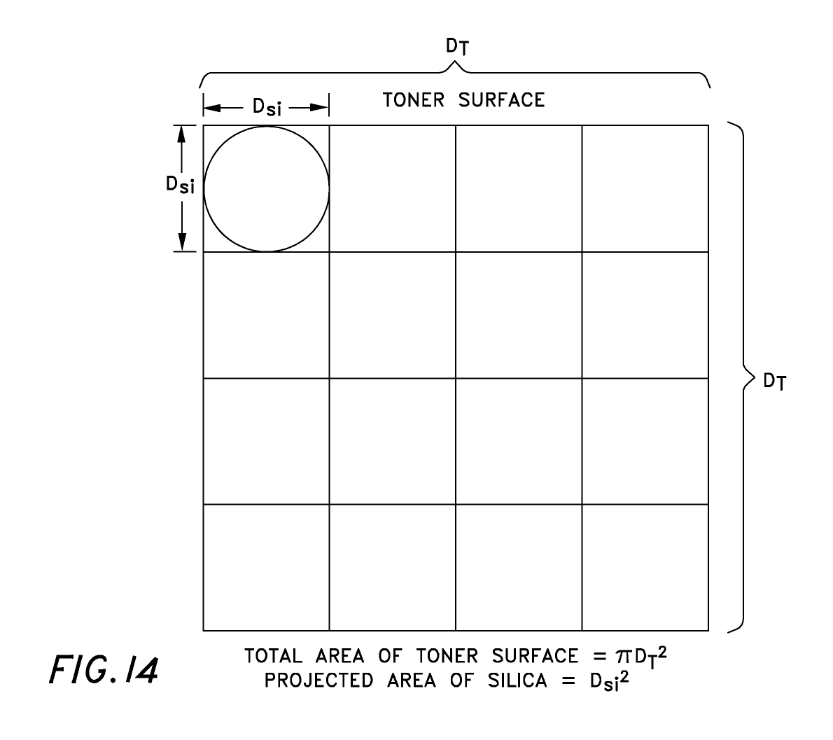

More particularly, the toner in accordance with the present invention includes large and small extraparticulate particles having concentrations by weight that preferably optimize surface coverage of the toner particles by the extraparticulate particles. In referring to surface coverage by area (surface coverage, surface coverage area), the total area of toner surface=πD_{T}² and the projected area of silica=Dₛᵢ², as shown in FIG. 14. The extraparticulate particles of the present invention may be comprised of silica particles but may also be comprised of an extraparticulate with similar physical characteristics to silica including material such as titanium dioxide, polymer microspheres, polymer beads, cerium oxide, zinc stearate, alumina, and the like. In one embodiment, surface coverage of toner particles by large extraparticulate particles is in a range of about 5 to 50 percent and surface coverage of toner particles by small extraparticulate particles is in a range of about 50 to 150 percent.

A toner may be prepared with the required calculated surface area coverage of extraparticulate particles by incorporation of a specific weight percent of each of the large and small extraparticulate particles by taking into account the mean diameter of the toner, the specific gravity of the toner and mean diameters and densities of each of the large and small extraparticulate particles.

For example, for a 12 μm mean diameter toner with specific gravity of 1.1 g/cm³ combined with large extraparticulate particles having a mean diameter of 40 nm and a specific gravity of 2.2 g/cm³ and small extraparticulate having a mean diameter of 10 nm (nanometers) and specific gravity of 2.2 g/cm³, the surface area coverage of the large extraparticulate of 5 to 50 percent corresponds to a concentration by weight of 0.16 percent to 1.6 percent and the surface area coverage of the small extraparticulate of 50 to 150 percent corresponds to a concentration by weight of 0.45 to 1.35 percent.

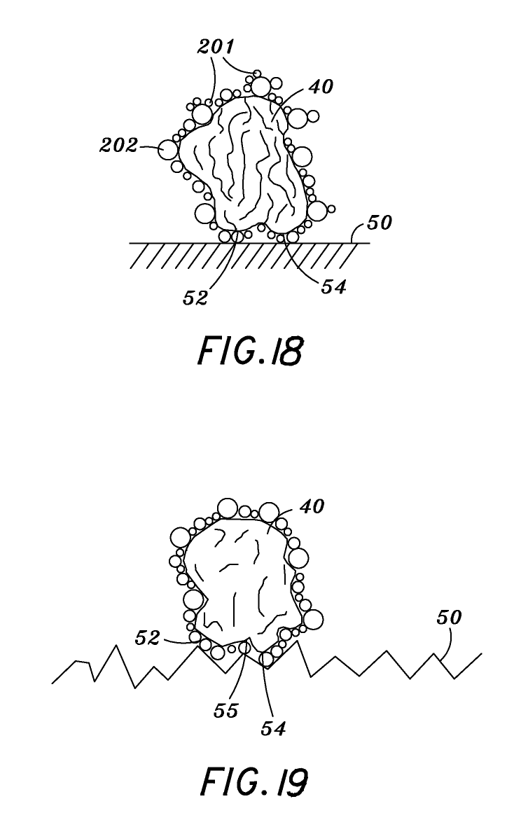

Interaction from adhesion forces between toner particle contact points and silica particle contact points and the developer roller surface depends upon n and nₚ, the number of contact points, as described above in Equation 5. As shown in FIG. 19, the developer roller surface 50, when magnified, exhibits a rough profile of peaks and valleys. What appeared to be two contact points, in the two-dimensions represented in FIGS. 15 and 18, is shown to be three contact points in the two-dimensions represented in FIG. 19. When the surface roughness is considered, contact point 55 is relevant. This was not apparent when the surface roughness was ignored, as depicted in FIGS. 15 and 18, where only contact points 52 and 54 were noticed. Thus, the number of contact points also depends upon the actual surface roughness. To define a suitable surface roughness, one must select the corresponding average roughness, Rₐ, the average maximum height of the surface profile, R_{z}, and the peak density, P_{c}(3). Experimental results demonstrated that the adhesion forces also depend upon the number of contact points represented by the number of surface peaks that interact with the toner and silica particles. Thus, n and nₚ are more fully understood to represent the number of contact points that interact between the surface of particles and the profile of peaks on a surface plane.

R_{z} is the average of the successive values of Rᵢᵢ calculated over the evaluation length, L. Rᵢᵢ is the vertical distance between the highest and lowest points of the profile within a sampling length segment labeled i.

Peak density, P_{c}, (frequency of peaks) is the number of SAE peaks per unit length measured at a specified peak count level. The frequency of peaks is important to achieve the correct balance between adhesion forces between the thin layer forming member (for example, a doctor blade) and the toner particles and the adhesion forces between the developer roller surface and the toner particles. The surface roughness of the doctor blade surface, facing the developer roller surface, may also be defined to minimize adhesion forces between the toner particles and the doctor blade.

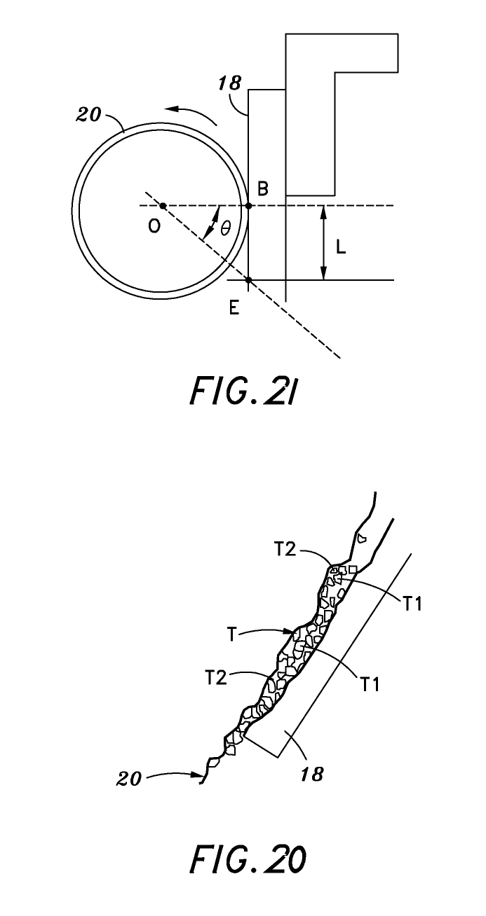

Controlling the adhesion forces between the doctor blade, toner, and developer roller ensure sufficient electrostatic charging and transport of toner to the development gap, where toner, with sufficient electrostatic charge jumps to the latent image on the photoreceptor surface. As shown in FIG. 20, the doctor blade 18 has a predetermined roughness profile that cooperates with the roughness profile of toner support member 20. Toner T1 travels between the doctor blade 18 and the toner support member 20, becoming electrostatically charged due to the friction provided between the two surfaces of predetermined roughness profile. If the roughness profile is such that toner T2 does not adequately incur frictional forces between the toner support member 20 and doctor blade 18, then insufficient charging results for development of toner T2. Toner charging and transport are enhanced when the doctor blade surface roughness is such that R_{z}, of the doctor blade, is less than or equal to 6.65 μm (micro-meters). R_{z}, of the doctor blade, may also be less than or equal to 1.65 μm

Another aspect of the doctor blade that affects toner adhesion and transport is the amount of pressing force applied by the doctor blade to the developer roller surface. The mass, shape, and size of the doctor blade contribute to the pressing force exerted on the developer roller surface. Excessive pressing force prematurely damages the toner particles, distorting the particle shape, leading to a change in the number of contact points after the toner particle is compressed. An increase in the number of contact points would contribute to an increase in adhesion forces on the toner particle. Such an event would lead to insufficient amounts of toner jumping across the development gap. Insufficient pressing force does not supply adequate friction to charge the toner to a state that the latent image charge will attract the toner particle across the development gap. If the toner does not readily jump from the developer roller to the photoreceptor latent image, then larger quantities of toner, needing larger capacity equipment, and a longer time for developing an image would result. Thus, improving toner jumping can shorten image development time and minimize device size.

Referring to FIG. 21, a doctor blade 18 contacts the developer roller surface 20 at point B. The distal end of the doctor blade 18 is at point E. The center of the developer roller is represented by point O. The extension distance, the amount of doctor blade length that overhangs from point B to point E is represented as L. Pressing force applied by the doctor blade depends upon the extension distance, L. The desirable extension distance is such that L is greater than zero, but less than or equal to r×(tan θ), with the preferred extension distance is such that L=r×(tan θ), where r is the developer roller 20 radius and θ is the angle spanned, in the direction counter to rotation, between point B and point E. The present invention can also function well when the direction of rotation is reversed.

In a further innovative aspect, the toner in accordance with the present invention has development efficiency in a range of about 80 to 99 percent over a wide range of bias voltages.

In one embodiment, a development system of the present invention may comprise a toner support member and a photoreceptor positioned in spaced relation. In operation, the photoreceptor is initially charged uniformly and then exposed to a light image representative of a desired image that discharges specific areas of the image bearing surface of the photoreceptor. Toner, which is carried to the developing region by the toner support member, is caused to jump the gap between the toner support member and the photoreceptor to the latent image, forming a developed image. Significantly, the electrostatic forces resulting from the DC bias voltage are sufficient to overcome toner adhesion forces without the use of AC voltages or some other means of releasing the toner free from the toner support member. This advantageously enables the development of color or “tone-on-tone” images without the need for an intermediate accumulator or some other intermediate transfer member.

The non-contact, single-component developing system of the present invention tends to facilitate efficient development of an electrostatic image and the consistent production of high quality output images. More particularly, the system of the present invention tends to reduce adhesion forces that hold toner particles to a toner support member to enable toner particles to more easily and efficiently jump from the toner support member to an image-bearing member such as a photoreceptor.

Referring in detail to the figures, FIG. 1 shows a non-contact or jump developing system 10 for use with a single-component toner in accordance with the present invention. The developing system 10 preferably includes a toner support member 20, such as a roller, and a photoreceptor 30, such as a photosensitive drum or belt. The toner roller 20 and photoreceptor 30 are aligned in spaced relation to form a gap 28 at the “developing region” 29. Preferably, the gap 28 is approximately 150 microns or less. A metering bar 24 may contact the toner roller 20 and acts to create a thin layer and to charge the toner particles 22 on the toner support member 20 from a toner reservoir or supply (not shown). The developing system 10 may also include an electrically coupled charger element 32 and an array of light emitting diodes (LEDs) 34.

In operation, the surface 31 of the photoreceptor 30 may be initially uniformly charged by the charger element 32 to a potential in the range of approximately −700 to −750 V (DC). The photoreceptor 30 may be constructed of a material that is conductive (i.e., allows a charge to dissipate) only when exposed to light. To create the desired electrostatic latent image on the photoreceptor 30, light is radiated from the arrays of LEDs 34, through the photoreceptor 30, onto the surface 31 to dissipate the charge in a pattern to form a latent image corresponding to a desired output image. After exposure of the photoreceptor 30 to light the potential of the latent image areas on the photoreceptor 30 is reduced to a range of approximately −50 V (DC).

The toner roller 20 may be biased to a potential approximately equal to the potential of the non-image areas on the image-bearing surface 31, but between the potential of the image and non-image areas. As the toner roller 20 carries the toner 22 into the developing region 29, the difference between the bias voltage on the toner roller and the potential difference associated with the latent electrostatic image areas on the surface 31 of the photoreceptor 30, which is approximately 650 V (DC), preferably exerts a force of sufficient magnitude on the toner particles 22 to cause the toner particles 22 to jump the gap 28 between the toner roller 20 and the photoreceptor 30 and adhere to the latent electrostatic image areas on the surface 31 of the photoreceptor 30. The voltage difference between the non-image areas of the surface 31 and the toner roller 20, which is approximately zero V (DC), tends to exert zero force on the toner particles 23 on the toner roller 20.

As shown in FIG. 2, for toner particles 22 to jump the gap 28 during the development process, the electrostatic, or Coulombic, force C acting upon the toner particle 22 must be sufficient to overcome the adhesion force A that adheres the toner particle 22 to the toner roller 20. If not, development efficiency and, thus, image quality tend to suffer. To reduce the effect of the adhesion forces, conventional methods tend to include the use of AC voltage or some other means of agitating the toner. Significantly, as discussed in detail below, the toner in the development system of the present invention advantageously reduces the effect of adhesion forces on the development process without resort to AC voltage or other means to agitate the toner. This tends to be of particular significance with regard to color or “tone-on-tone” developing because it enables the simplification and reduction in size and, thus, cost of the development system by eliminating the need for an intermediate accumulator or some other intermediate transfer means.

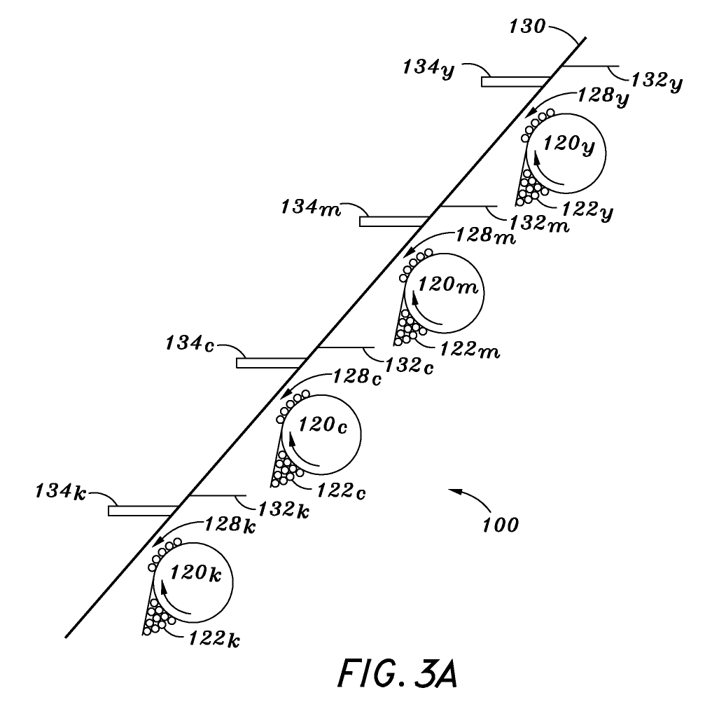

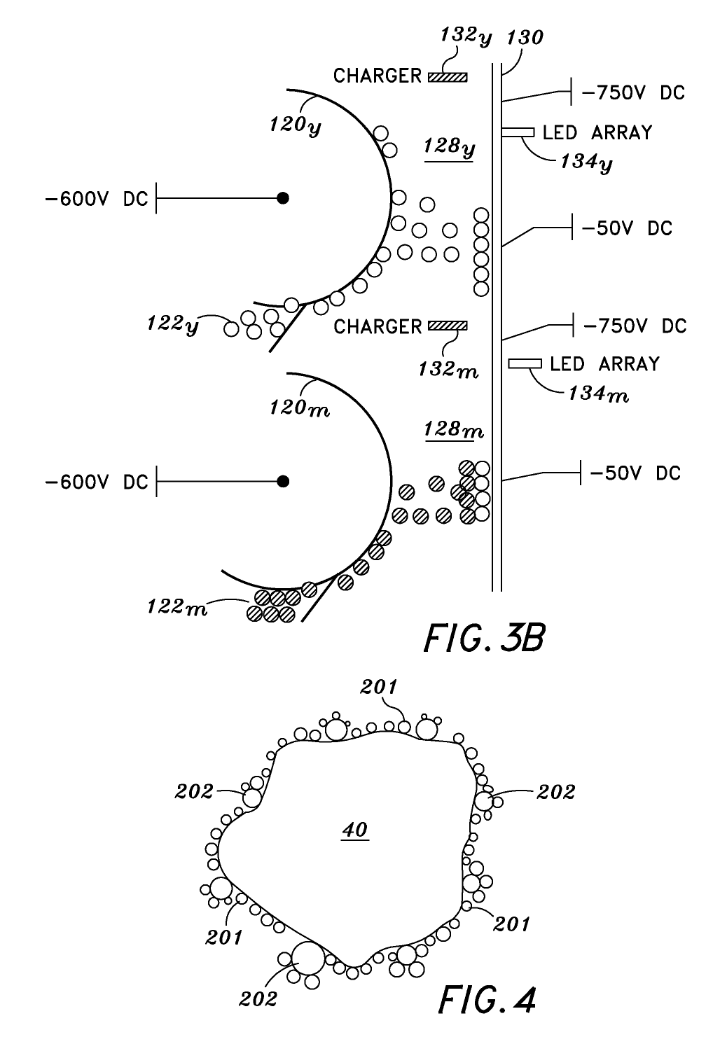

Turning to FIG. 3A, a non-contact, single-component color or “tone-on-tone” developing system 100 in accordance with the present invention is shown to include a photoreceptor, e.g., an image-bearing belt 130, and four toner support members 120y, 120m, 120c, and 120k for delivery of toners preferably comprising toner of four different color pigments. The toner support members 120y, 120m, 120c, and 120k, respectively, preferably deliver yellow toner particles 122y, magenta toner particles 122m, cyan toner particles 122c, and black toner particles 122k to the developing regions 128y, 128m, 128c, and 128k interposing the toner support members 120y, 120m, 120c, and 120k and the image-bearing belt 130. The developing system 100 may include four charger elements 132y, 132m, 132c, and 132k, respectively, and four LED arrays 134y, 134m, 134c, and 134k, respectively, positioned along the belt 130 prior to a corresponding toner support members 120y, 120m, 120c, and 120k. By including four charger elements and four LED arrays, the developing system 100 of the present invention is capable of developing a color image in a single pass of the photoreceptor 130. Alternatively, the developing system 100 may include two charger elements and two LED arrays to enable a color image to be developed in two passes of the photoreceptor 130, or one charger element and one LED array to enable a color image to be developed in four passes of the photoreceptor 130.

In operation, as shown in greater detail in FIG. 3B, the first charger element 132y initially uniformly charges the image-bearing belt 130 to a potential in the range of approximately −700 V (DC) to −750 V (DC). Next, the first LED array 134y radiates light onto the image-bearing belt 130 in a specific pattern corresponding to portions of a desired image that require the inclusion of the color yellow. The charge on the areas of the belt 130 exposed to the light dissipates to a potential of approximately −50 V (DC). After the image-bearing belt 130 passes the first developing region 128y adjacent the first toner support member 120y where toner is directed to the latent electrostatic areas along the surface of the belt, the belt 130 is again uniformly charged to a potential in the range of approximately −700 V (DC) to −750 V (DC) by the second charger element 132m. Light is then radiated from the second LED array 134m onto the belt 130 in a specific pattern corresponding to portions of a desired image that require the inclusion of the color magenta, including portions that already have yellow toner deposited thereon. The charge on portions of the belt 130 that do not already have toner deposited thereon dissipates, causing those portions of the belt 130 to have a potential of approximately −50 V (DC). However, the charge on portions of the belt 130 that already have toner deposited thereon tends to dissipate less, causing those portions of the belt 130 to have a potential in a range of approximately −150 V to −250 V (DC). After the image-bearing belt 130 passes the second developing region 128m adjacent the second toner support member 120m where toner is directed to the latent electrostatic areas along the surface of the belt, the process is repeated for the two remaining colors (e.g., cyan and black).

Because the charge on portions of the belt 130 already having toner deposited thereon may only dissipate to a potential of approximately −150 V to −250 V (DC), the voltage difference applied to the toner particles to cause the toner particles to jump the gap 128 and adhere to these portions of the belt 130 is significantly reduced to approximately 450 V to 600 V (DC). The reduction in the voltage difference results in a reduction of the electrostatic forces acting on the toner particles. As described more fully below, the present invention effectively reduces the effect of adhesion forces on the development process advantageously over a wide range of bias voltages. As a result, development efficiency and, thus, image quality tend to be enhanced.

Referring back to FIG. 2, the adhesion force A tends to be distributed over and directly proportional to the size of a contact area between the toner particle 22 and the toner roller 20. Thus, the larger the contact area between the toner particle 22 and the toner roller 20 surface, the greater the magnitude of the adhesion force A. Accordingly, the present invention effectively reduces the negative effect of adhesion forces on the development process by altering or manipulating the formulation of extraparticulate particles in a toner to reduce the contact area between the toner particles 40 and the toner support member 20. As shown in FIG. 4, large and small extraparticulate particles 202 and 201, which are mixed with toner particles such that they are well dispersed onto the surface of the toner particles 40, in a manner known in the art, adhere to the surface of a toner particle 40. The extraparticulate particles 202, 201 provide much smaller contact points with the toner support member 20, thus reducing the adhesion force between the toner particle 40 and the toner support member 20.

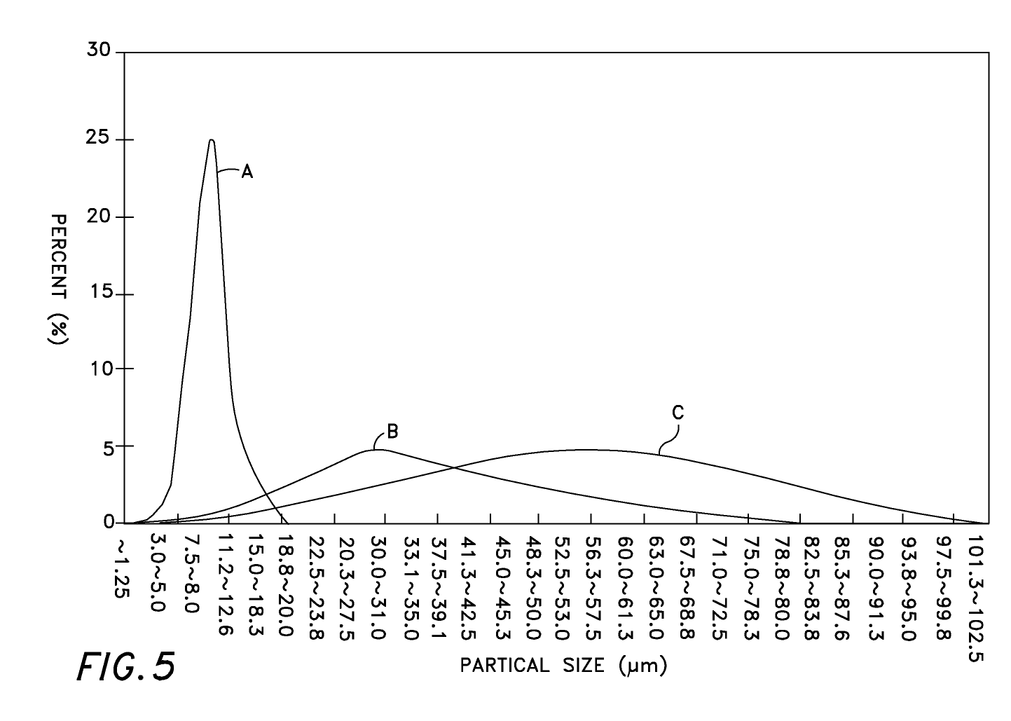

Extraparticulate particles such as silica are commonly combined with toner particles in electrophotographic machines to improve the flowability and durability of the toner. The large particles of silica 202, which are typically in the range of approximately 20-50 nm in diameter, are typically mixed with toner particles 40. The small particles of silica 201, which are typically in the range of 6-12 nm in diameter, are typically mixed with toner particles 40 to improve or enhance the flowability of the toner particles. The graph in FIG. 5 shows a typical particle size distribution for silica particles with mean diameters of approximately 10 nm (curve A), 30 nm (curve B) and 40 nm (curve C).

In one embodiment, a single-component toner of the present invention preferably combines extraparticulate particles with toner particles. Alternatively, particles of extraparticulates such as titanium dioxide, polymer microspheres, polymer beads, cerium oxide, zinc stearate, alumina, and the like, may be combined with the toner particles and produce the same result. The silica particles may be formed from fumed silica in a manner known in the art and include both large and small silica particles 202, 201 of sizes in the ranges discussed above. The toner particles 40 may be formed from a variety of formulations known in the art. The concentration by weight of the small silica particles 201 and large silica particles 202 relative to the toner particles 40 is manipulated to optimize the coverage of toner particle surface area by the silica particles. Referring to FIG. 4, the surface coverage of the toner particle 40 by large silica particles is preferably in a range of about 5 to 50 percent, and most preferably about 15 percent, while the surface coverage of the toner particle 40 by small silica particles 201 is preferably in a range of about 50 to 150 percent, and most preferably about 100 percent surface coverage. As shown in FIG. 4, a surface coverage greater than 100 percent is realizable because the small silica particles 201 tend to adhere to both the toner particle 40 and the large silica particles 202.

The relationship between silica concentration by weight and toner surface coverage is provided by the following equations:

where

cₘ=n_{Si}ρ_{Si}(D_{Si})³/ρ_{T}(D_{T})³

and

s_{c}=(1/π)n_{Si}(D_{Si})²/(D_{T})²

Where the percent surface coverage (s_{c}) is defined as the number of silica particles (nₛᵢ) times their projected area (D_{Si})² divided by the area of a spherical toner particle π(D_{T})², as shown in FIG. 14.

The equation,

s_{c}=(cₘ/π)(ρ_{T}/ρ_{Si})(D_{T}/D_{Si})

describes the surface coverage for single sized spherical particles. To take into account non-spherical particles, size distributions, and agglomerations this equation should be modified by adding an empirically obtained term beta=0.6 to the above equation. Therefore

s_{c}=(βcₘ/π)(ρ_{T}/ρ_{Si})(D_{T}/D_{Si})

cₘ is the calculated concentration by weight of silica particles relative to toner particles;

s_{c} is the percentage of surface coverage of the toner particle by silica particles;

n_{Si} is the mean number of silica particles;

ρ_{Si} is the specific gravity of silica (2.2);

D_{Si} is the mean diameter of the silica particles (nm);

ρ_{T} is the specific gravity of a toner particle (1.1); and

D_{T} is the mean diameter of the toner particles (μm).

Table 1 below provides the corresponding values of silica concentration and surface coverage for small and large silica particles.

TABLE 1

| Toner | Silica | | |
|---|---|---|---|
| Diameter | Diameter | Concentration | S_{c} |
| (μm) | (nm) | (%) | (%) |
| 12 | 10 | 0.9 | 100 |
| 12 | 40 | 0.5 | 14 |
| 16 | 10 | 0.7 | 93 |
| 16 | 40 | 0.4 | 15 |

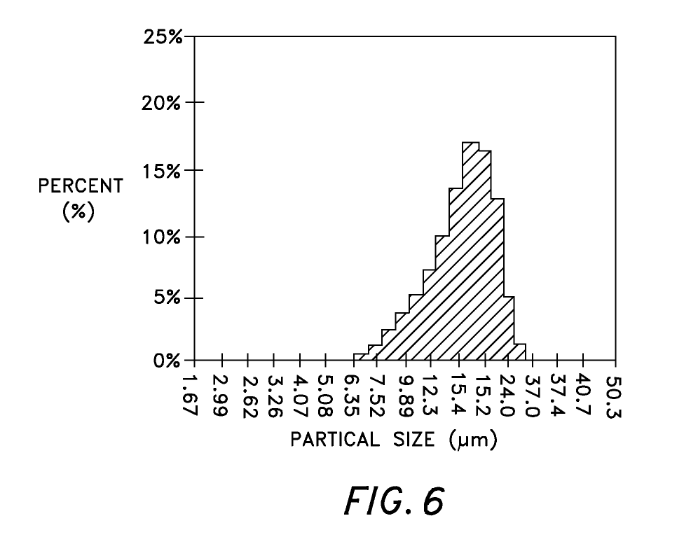

The following experiments were conducted to evaluate the development efficiency of the toner over a wide range of bias voltages. The toner having a mean diameter particle size of 16 μm (see FIG. 6 for a typical mean diameter particle size distribution for toner) was combined with silica particles and subjected to bias voltages ranging from approximately 100 V (DC) to 800 V (DC). The experiments were conducted in accordance with the parameters appearing in Table 2 below:

TABLE 2

| | small | | % by wt. | | | |
|---|---|---|---|---|---|---|
| Exp. | silica | large silica | small | % by wt. | T/RH | Q/M |
| No. | size (nm) | size (nm) | silica | large silica | (° F./%) | (μC/g) |
| 1 | 10 | 40 | 0.3 | 0.4 | 73/53 | 7.5 |
| 2 | 10 | 40 | 0.7 | 0.4 | 70/55 | 5.0 |
| 3 | 10 | 40 | 0.9 | 0.4 | 71/60 | 5.6 |
| 4 | 10 | 40 | 1.1 | 0.4 | 73/53 | 6.6 |
| 5 | 10 | 40 | 0.7 | 0.2 | 74/57 | 5.7 |
| 6 | 10 | 40 | 0.7 | 0.6 | 73/54 | 5.8 |

The silica particle size depicted in Table 2 corresponds to the mean diameter of the silica particles having a size distribution (see FIG. 5).

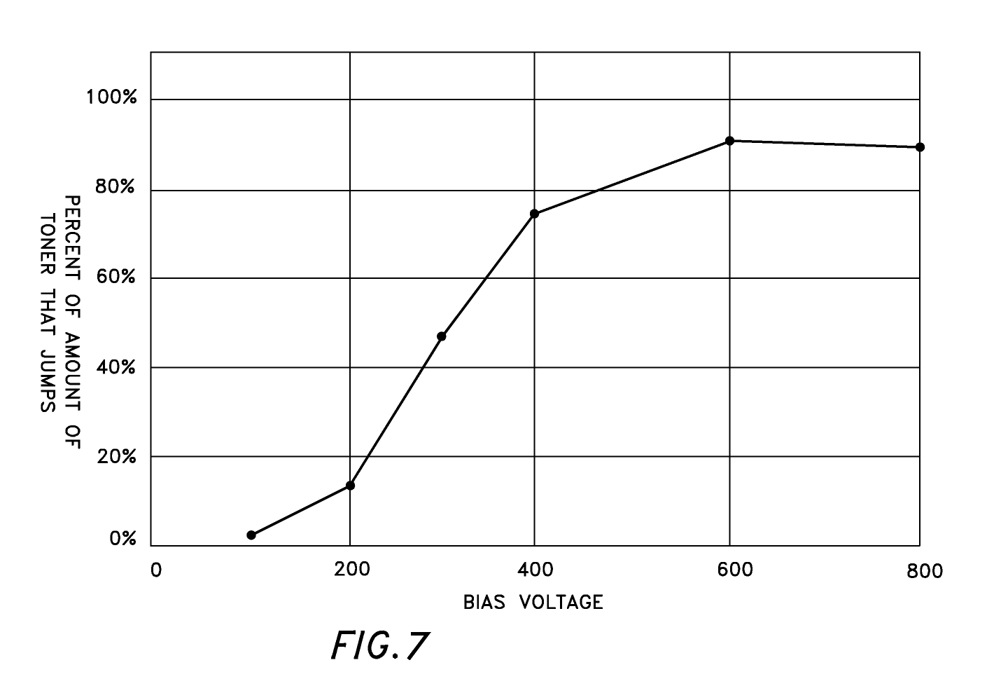

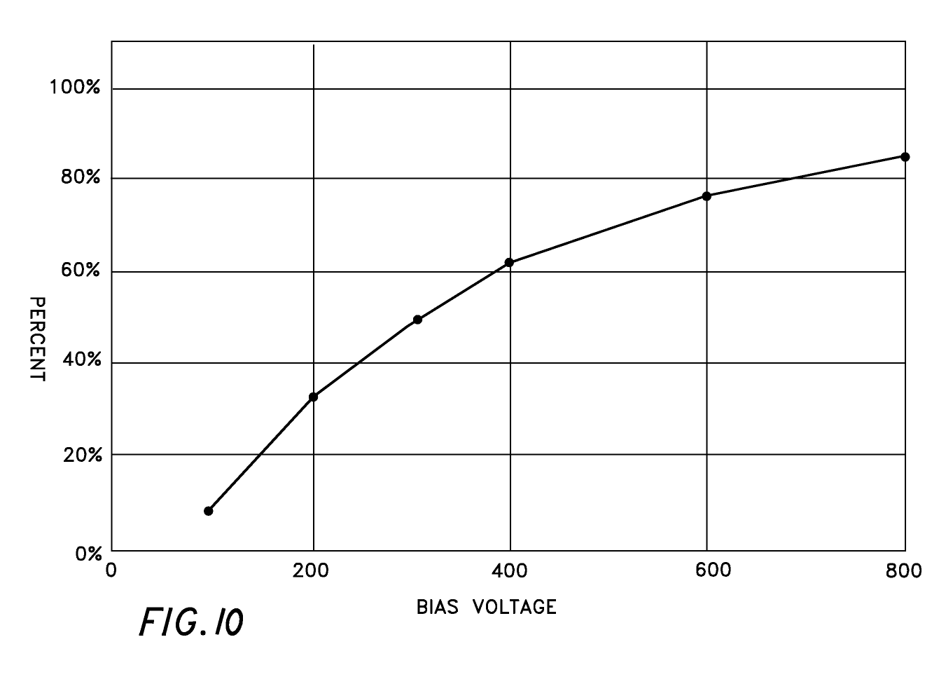

The development efficiency, which is shown as a percentage in FIGS. 7 through 13, was measured as the ratio of the mass per unit area of the developed toner transferred to the surface of the photoreceptor to the combined mass per unit area of the developed toner and the residual toner carried on the toner support member following the development process. Alternatively, the development efficiency may be measured as the ratio of the mass per unit area of the developed toner transferred to the surface of the photoreceptor to the mass per unit area of the toner carried on the toner support member prior to development.

The toner support member and image-bearing surface were positioned in spaced relation in accordance with the prescribed gap discussed above and rotated at the same speed. After a prescribed voltage was applied, the mass per unit area of the toner particles that jumped the gap and adhered to the image-bearing surface was measured by aspirating a portion of toner layer from the surface of the photoreceptor, weighing the aspirated toner, measuring the aspirated area, and then dividing the weight of the aspirated toner by the aspirated area. The mass per unit area of the residual toner left on the toner support member was measured in the same fashion. The development efficiency was calculated as follows:

$$Efficiency = \frac{Developed Mass Per Unit Area}{( \begin{matrix}Developed Mass Per Unit Area + \\ Residual Mass Per Unit Area\end{matrix} )}$$

These steps were carried out for each prescribed bias voltage for each tested toner.

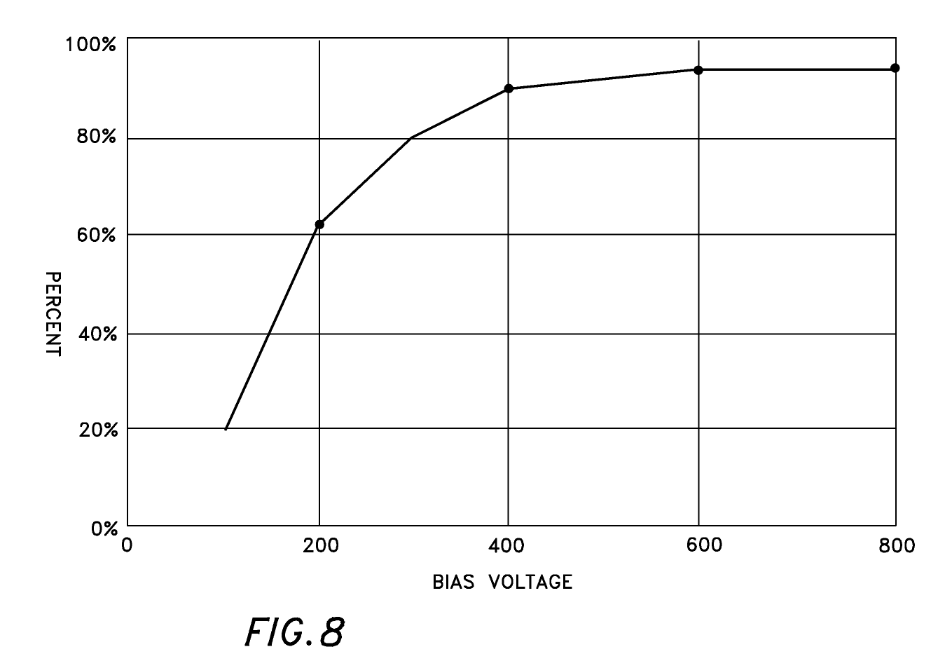

The results of experiments 1 through 6 (shown in Table 2) appear in FIGS. 7 through 12, respectively, as graphs wherein the percentage development efficiency is plotted against the applied bias voltage. As shown in FIG. 8, the silica concentration of 0.4 percent by weight of large silica and 0.7 percent by weight of small silica resulted in the highest and most consistent development efficiency over a wide range of bias voltages. More particularly, this concentration resulted in over 90 percent development efficiency, i.e., development efficiency in a range of about 90 to 98 percent, when the toner support member was subjected to bias voltages ranging from 400 V (DC) to 800 V (DC).

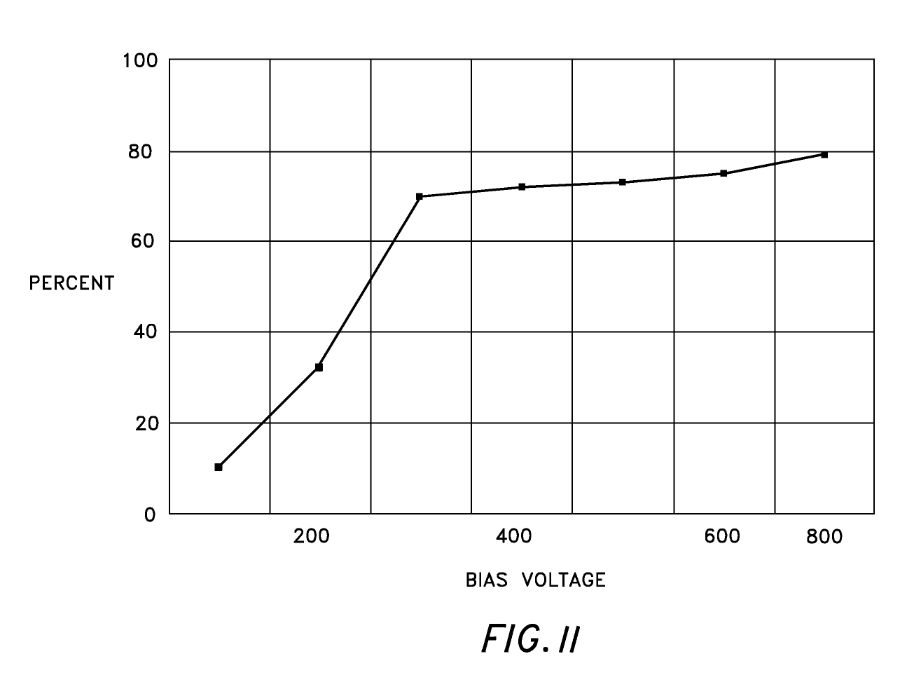

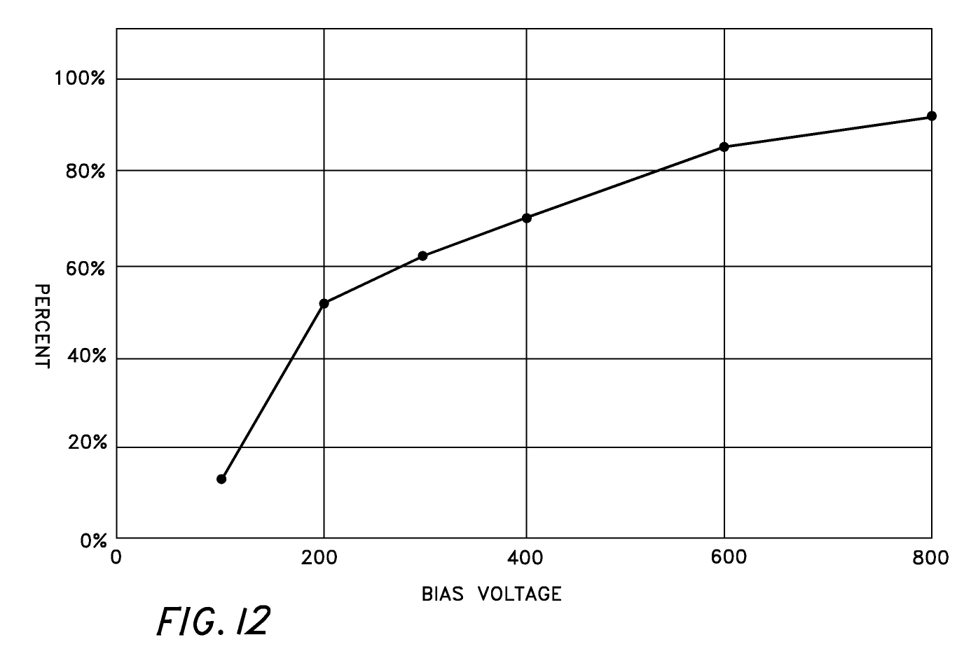

As shown in FIGS. 7, 9, and 10, the development efficiency tends to decrease as the concentration by weight of small silica particles increases or decreases from 0.7 percent by weight. Similarly, as shown in FIGS. 11 and 12, the development efficiency also tends to decrease as the concentration by weight of large silica particles increases or decreases from 0.4 percent by weight.

Those of skill in the art will appreciate that by adhering to the surface coverage values for extraparticulate particles provided herein, the optimum concentration by weight of extraparticulate particles can be determined for a variety of silica and toner particle sizes (e.g., toner particles in a range of about 6 to 24 μm). For example, the calculated silica concentrations for a toner having a mean diameter particle size of 12 μm, and small and large silica having mean diameter particle sizes of 10 and 40 nm, are 0.5 percent and 0.9 percent respectively.

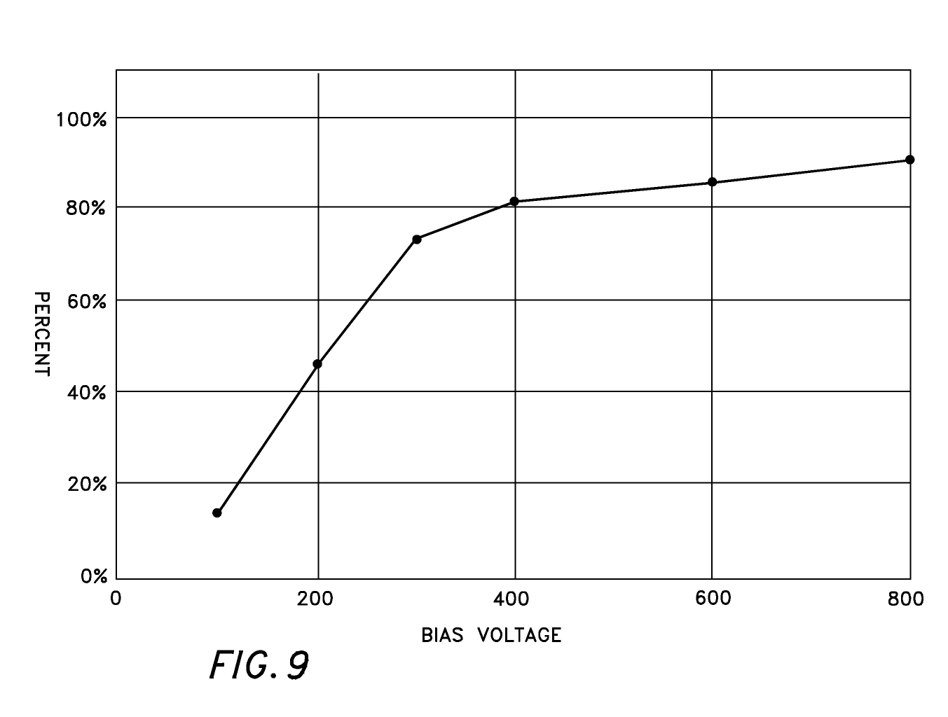

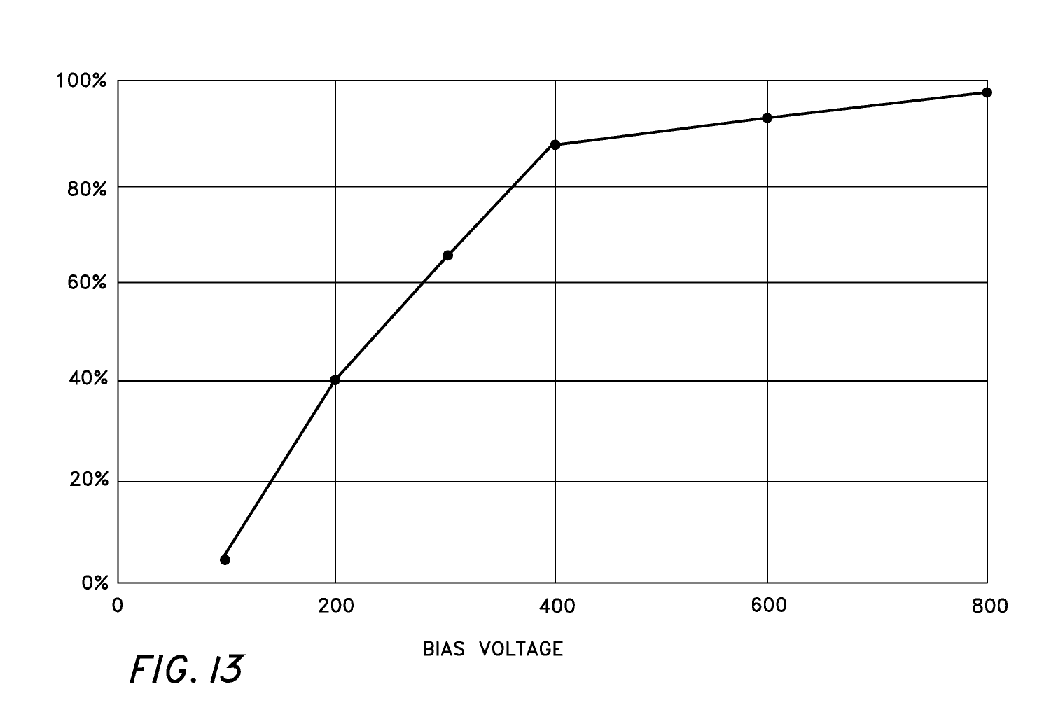

A toner comprising toner particles having a mean diameter particle size of 12 μm was tested in accordance with the procedure described above to determine its development efficiency across a wide range of bias voltages. The test parameters included small and large silica particles having mean diameters of 10 and 40 nm, respectively, a mean Q/M value of 5.86 μC/g, as measured by Torrey Pines Research's aspirator, for the toner and environmental conditions of 75° F. and 52 percent RH. As shown in FIG. 13, the development efficiency of this toner was comparable to the development efficiency of the toner having a mean diameter particle size of 16 μm shown in FIG. 9. The development efficiency ranges from nearly 90 percent to nearly 99 percent over a range of applied bias voltages of approximately 400 V (DC) to 800 V (DC). As indicated above, these efficiencies tend to ensure the consistent production of high quality images over a wide range of bias voltages.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

I claim:

1. An electrophotographic development apparatus, comprising:
a toner support member; and
a thin layer forming member for forming toner on the toner support member,
wherein a distance L from a contact point of the toner support member to a free edge of the thin layer forming member is set to meet the following equation:
0<L≦r×(tan θ),
where L denotes the distance, r an outer radius of the toner support member, and θ is an angle formed by the point, on the free edge of the thin layer forming member, closest to the toner support member at a position in an upstream side relative to a rotational direction of the toner support member from a contact point of the thin film forming member and the toner support member.

2. An electrophotographic development apparatus, comprising:
a toner support member; and
a thin layer forming member for forming toner on the toner support member,
wherein a distance L from a contact point of the toner support member to a free edge of the thin layer forming member is set to meet the following equation:
0<L≦r×(tan θ),
where L denotes the distance, r an outer radius of the toner support member, and θ is an angle formed by the point, on the free edge of the thin layer forming member, closest to the toner support member at a position in an upstream side in an opposite direction from a rotational direction of the toner support member from a contact point of the thin film forming member and the toner support member.

3. An electrophotographic development apparatus, comprising:
a toner support member; and
a thin layer forming member for forming toner on the toner support member,
wherein a distance L from a contact point of the toner support member to the free edge of the thin layer forming member is set to meet the following equation:
0<L≦r×(tan θ),
where L denotes the distance, r an outer radius of the toner support member, and θ is an angle formed by the point, on the free edge of the thin layer forming member, closest to the toner support member at a position in a downstream side relative to a rotational direction of the toner support member from a contact point of the thin film forming member and the toner support member.

4. An electrophotographic development apparatus, comprising:
a toner support member; and
a thin layer forming member for forming toner on the toner support member,
wherein a surface roughness R_{z} of the thin layer forming member, on the thin layer forming member surface facing the toner support member, is less than or equal to 6.65 μm.

5. The electrophotographic development apparatus according to claim 4,
wherein the electrophotographic development apparatus develops a latent image formed on a latent image carrying member, and
a distance L from a contact point of the toner support member to the free edge of the thin layer forming member is set to meet the following equation:
0<L≦r×(tan θ),
where L denotes the distance, r an outer radius of the toner support member, and θ is an angle formed by the point, on the free edge of the thin layer forming member, closest to the toner support member at a position in an upstream side relative to a rotational direction of the toner support member from a contact point of the thin film forming member and the toner support member.

6. The electrophotographic development apparatus according to claim 4, wherein the surface roughness R_{z} of the thin layer forming member, on the thin layer forming member surface facing the toner support member, is less than or equal to 1.65 μm.
